(19) United States
(12) Patent Application Publication
(10) Pub. No.: US 2025/0045702 A1
(43) Pub. Date: Feb. 6, 2025

(54) INFORMATION PROCESSING DEVICE, INFORMATION PROCESSING METHOD, AND A NON-TRANSITORY COMPUTER READABLE MEDIUM

(71) Applicant: Matchbox Technologies, Inc., Niigata-shi (JP)

(72) Inventor: Takashi SATO, Niigata-shi (JP)

(73) Assignee: Matchbox Technologies, Inc., Niigata-shi (JP)

(21) Appl. No.: 18/926,616

(22) Filed: Oct. 25, 2024

Related U.S. Application Data
(63) Continuation of application No. PCT/JP2023/016726, filed on Apr. 27, 2023.

(30) Foreign Application Priority Data
Jul. 20, 2022 (JP) 2022-115443

(51) Int. Cl. G06Q 10/1053; G06Q 10/0631

(52) U.S. Cl. CPC G06Q 10/1053; G06Q 10/063112

(57) ABSTRACT

A server of an employment registrant management system performs, as its functions, steps of accepting employment recruitment information from the business entity, and presenting the employment recruitment information to the registrants, accepting, from the registrants who request application for the employment recruitment information, employment request information for the employment recruitment information, and presenting the employment request information to the business entity, accepting, from the business entity, employment approval information for approving employment of the registrants related to the accepted employment request information, and presenting the employment approval information to the registrants, obtaining work information indicating that the registrants have been employed related to the employment recruitment information with the employment approval information, and obtaining skill information regarding skills based on the work information, and providing the obtained skill information in association with stored information of the registrants.

### CROSS-REFERENCE TO RELATED APPLICATIONS

This application is a Continuation Application of No. PCT/JP2023/016726, filed on Apr. 27, 2023, and the PCT application is based upon and claims the benefit of priority from Japanese Patent Application No. 2022-115443 filed on Jul. 20, 2022, the entire contents of which are incorporated herein by reference.

### FIELD

Embodiments described herein relate generally to an information processing device, and an information processing method, and a non-transitory computer readable medium.

### BACKGROUND

When business entities (employers) secure workers, since skills required for the business for which the workers are to be employed are different depending on each of the types of industries of the business entities, job types, and employment details, it is important to secure workers with the skills corresponding to the business. Therefore, the skills of workers are managed according to the past employment.

For example, conventional system is disclosed a management system that estimates and manages the skills of employees. This management system analyzes the structured data (attribute information such as organizations to which employees belong, businesses, projects, clients, and qualifications) and the non-structured data (action history information such as electronic mails, schedules, documents, and free comments) of the employees, and estimates and manages the skills of the employees, thereby making it possible to correctly identify the skills of each of the employees.

Incidentally, it is important for the business entities (employers) as described above to have workers, such as student part-timers and part-timers, work during designated hours, i.e., to secure the so-called shifts. This is because in retail stores such as supermarkets and convenience stores, and restaurants such as family restaurants and taverns, a required number of staff members is different depending on hours, and thus it is necessary to appropriately secure the number of shifts according to hours. However, there are cases where required shifts cannot be secured only with workers such as student part-timers and part-timers employed by a business entity, and in such cases, it is also necessary to perform new employment on the assumption of short-term (one-time) employment.

### SUMMARY

The present disclosure describes a technology that facilitates new employment for securing required shifts.

### BRIEF DESCRIPTION OF DRAWINGS

FIG. 1 is a diagram illustrating a general configuration of an employment registrant management system 1 in Embodiment 1.

FIG. 2 is a block diagram illustrating a functional configuration of a terminal device 10 constituting the employment registrant management system 1 in Embodiment 1.

FIG. 3 is a diagram illustrating a functional configuration of a server 20 constituting the employment registrant management system 1 in Embodiment 1.

FIG. 4 is a diagram illustrating an example of a data structure of a registrant database 2021 stored in the server 20 constituting the employment registrant management system 1 in Embodiment 1.

FIG. 5 is a diagram illustrating an example of a data structure of an employment database 2022 stored in the server 20 constituting the employment registrant management system 1 in Embodiment 1.

FIG. 6 is a flowchart illustrating an example of a flow for performing registration processing by the employment registrant management system 1 in Embodiment 1.

FIG. 7 is a flowchart illustrating an example of a flow for performing employment approval processing by the employment registrant management system 1 in Embodiment 1.

FIG. 8 is a flowchart illustrating an example of a flow for performing skill information provision processing by the employment registrant management system 1 in Embodiment 1.

FIG. 9 is a diagram illustrating an example of a screen that accepts employment recruitment and that is displayed on the terminal device 10.

FIG. 10 is a diagram illustrating an example of a screen that displays employment applicants and that is displayed on the terminal device 10.

### DETAILED DESCRIPTION

In general, according to an embodiment of the present disclosure, there is provided a program that is to be executed by a computer including a processor and a memory, and that is for managing registrants who are registered for employment by a business entity. The memory stores information of the registrants. The program causes the processor to perform steps of accepting employment recruitment information from the business entity, and presenting the employment recruitment information to the registrants, obtaining work information indicating that the registrants have been employed related to the employment recruitment information with approval from the business entity, and obtaining skill information regarding skills based on the work information, and providing the obtained skill information in association with stored information of the registrants.

Embodiments of the present disclosure will be described below with reference to the drawings. The embodiments below are not intended to unnecessarily limit the scope of the present disclosure set forth in the claims. Not all of the elements illustrated in the embodiments are essential to the present disclosure.

Hereinafter, embodiments of the present disclosure will be described with reference to the drawings. In the following description, the same numerals are assigned to the same components. The names and functions of them are also the same. Accordingly, a detailed description of them will not be repeated.

Hereinafter, an employment registrant management system according to the present disclosure will be described. The employment registrant management system according to the present disclosure is a system for registering in advance information of employment applicants who request employment by a business entity, and for accepting application from registered registrants when there is employment recruitment (recruitment) from the business entity. For example, when employment recruitment information (recruitment information) is accepted from the business entity, the employment registrant management system presents the employment recruitment information to the registrants to accept employment request (application), and present it to the business entity. Then, with approval from the business entity, the registrants actually work. The employment registrant management system is a system for enabling smooth recruitment offering and securing of employees by such a configuration. Although this employment registrant management system will be described as a system that provides recruitment information of the working hours during which workers such as student part-timers and part-timers work in retail stores and the like on the assumption of short-term (one-time) employment, i.e., so-called shifts, this employment registrant management system may be a system on the assumption of long-term employment such as regular employment. In addition, it may be a system that accepts requests of shifts, and allows adjustment by a business entity. The employment registrant management system according to the present disclosure is, for example, a system provided as a web service, i.e., as a so-called Saas (Software as a Service), by a cloud server or the like, and the system is configured to be accessible by registrants who are registered for employment for a business entity or by a user that is a business entity through predetermined authentication.

Users utilizing the employment registrant management system according to the present disclosure may be not only a business entity that accepts employment applicants, such as a retail store, but also a group including a business entity. Here, the business entity is, for example, a company, a manager of a store such as a retail store and a restaurant, or a person who operates a store as an employee of a company that operates a store such as a retail store and a restaurant, or may be a business entity that is a store owner conducting a franchise chain business. In addition, the group may be a company that operates one or more stores such as retail stores and restaurants, or a person who provides the service of providing human resources to a store such as a retail store and a restaurant, or may be a company conducting a franchise chain business. Note that the group may be a company that operates one or more types of stores (of different businesses) such as retail stores and restaurants. Hereinafter, these will be collectively described as the business entity.

It is important for the business entity (employer) that employs workers as described above to have workers work during designated hours. At this time, since skills required for the business are different depending on each of the types of industries of the business entities, job types, and employment details, it is important to secure workers with the skills corresponding to the business, and to have the workers work. Therefore, it is necessary to appropriately manage the skills of employment applicants who request employment. However, such skills include skills acquired through actual employment, and skills necessary for employment, such as official qualifications. Thus, it is not easy to centrally manage the skills of different natures. Furthermore, since the skills acquired through actual employment as described above are different depending on the frequency, hours, and the like of the employment, and is also updated every day, it is not easy to manage the skills up to date.

Therefore, the employment registrant management system according to the present disclosure registers and stores the information of employment applicants for employment by a business entity. The skill information regarding skills is obtained from the work information indicating that registrants have applied and worked for the employment recruitment information of the business entity, and the obtained skill information is provided in association with the information of the registrants. Therefore, the employment information of the registrants can be reflected in real time as the skill information. This makes it possible to manage the skills of the registrants in detail and in real time.

In addition, the employment registrant management system according to the present disclosure accepts the employment request information for the employment recruitment information, and presents it to the business entity. At this time, the skill information of the registrants who request employment is also presented to the business entity. This makes it possible for the registrants with appropriate skills to be employed.

Furthermore, the employment registrant management system according to the present disclosure provides the skill information as first skill specific to the business entity, second skill not limited to the business entity, or third skill specific to the group including the business entity. Accordingly, since the skills can be hierarchically managed, it becomes possible to appropriately manage the skill of the registrants.

Note that, in the employment registrant management system according to the present disclosure, registrants are registered as, in addition to employees (internal employees) who are directly hired by the business entities, former internal employees who were previously hired by the business entities as full-time employees but already retired, i.e., so-called OBs and OGs, and external experienced persons who were hired and employed by the business entities for short terms (for example, even one day is allowed), and further, the information of persons who are registered for employment and have not been actually employed is also separately managed as external persons.

### Embodiment 1

Hereinafter, an employment registrant management system 1 will be described. In the following description, for example, when a terminal device 10 accesses a server 20, the server 20 responds information for generating a screen in the terminal device 10. The terminal device 10 generates and displays the screen based on the information received from the server 20.

### 1 General Configuration of Employment Registrant Management System 1

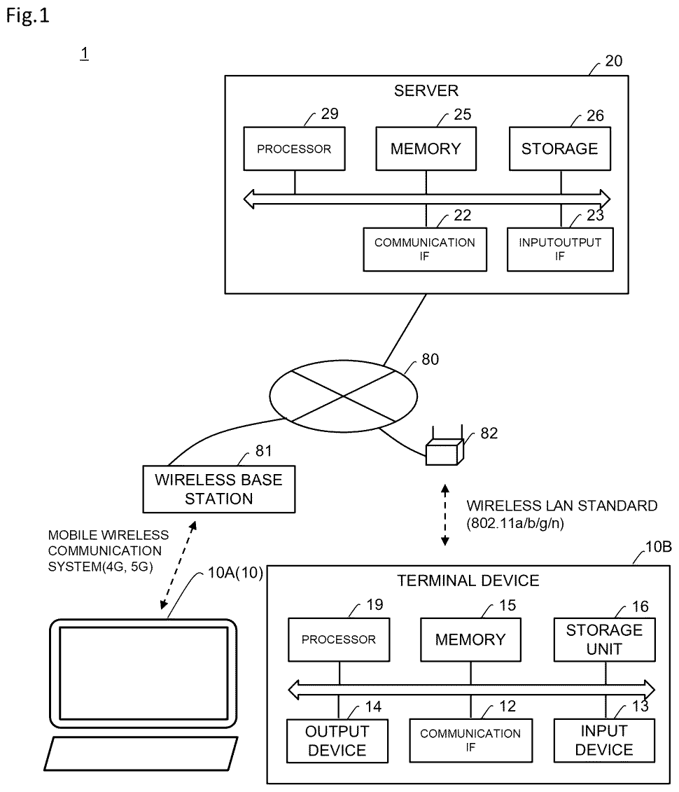

FIG. 1 is a diagram illustrating a general configuration of the employment registrant management system 1. As illustrated in FIG. 1, the employment registrant management system 1 includes a plurality of terminal devices (FIG. 1 illustrates a terminal device 10A and a terminal device 10B. Hereinafter, they may be collectively referred to as “the terminal device 10”), and the server 20. The terminal device 10 and the server 20 are communicatively connected to each other via a network 80. The network 80 is constituted by a wired or wireless network.

The terminal device 10 is a device operated by each user. Here, users are persons who use the terminal device 10 to perform registration for employment request, presentation of employment recruitment information, and application for the employment recruitment information, which are functions of the employment registrant management system 1, and includes, for example, the above-described registrants (including persons who are going to perform registration), business entities, and the like. The terminal device 10 is realized by a stationary PC (personal computer), a laptop PC, or the like. In addition, the terminal device 10 may be, for example, a tablet corresponding to mobile communication systems, or a mobile terminal such as a smart phone.

The terminal device 10 is communicatively connected to the server 20 via the network 80. The terminal device 10 is connected to the network 80 by communicating with communication equipment, such as a wireless base station 81 corresponding to communication standards such as 4G, 5G, and LTE (long term evolution), and a wireless LAN router 82 corresponding to the wireless LAN (local area network) standards such as IEEE (Institute of Electrical and Electronics Engineers) 802.11. As illustrated in FIG. 1 as the terminal device 10B, the terminal device 10 includes a communication IF (interface) 12, an input device 13, an output device 14, a memory 15, a storage unit 16, and a processor 19.

The communication IF 12 is an interface for inputting and outputting signals for the terminal device 10 to communicate with an external device. The input device 13 is an input device (for example, a keyboard, a touch panel, a touchpad, a pointing device such as a mouse, and the like) for accepting an input operation from a user. The output device 14 is an output device (a display, a speaker, and the like) for presenting information to the user. The memory 15 is for temporarily storing a program, data to be processed by the program, and the like, and is, for example, a volatile memory such as a DRAM (dynamic random access memory). The storage unit 16 is a storage device for saving data, and is, for example, a flash memory or an HDD (hard disc drive). The processor 19 is hardware for executing a set of instructions written in the program, and includes an arithmetic unit, a register, and a peripheral circuit.

The server 20 is a device that manages information regarding the registrants registered as employment seekers, and the like. The server 20 accepts registration information from a user who is an employment seeker, and registers the user as a registrant. The server 20 accepts and registers employment recruitment information from a user that is a business entity, presents the employment recruitment information to accept an application from the registrant, and accepts an input approving employment of the registrant. In addition, the server 20 obtains the skill information regarding skills from the work information of the registrant, and provides the obtained skill information in association with the information of the registrant.

The server 20 is a computer connected to the network 80. The server 20 includes a communication IF 22, an input/output IF 23, a memory 25, a storage 26, and a processor 29.

The communication IF 22 is an interface for inputting and outputting signals for the server 20 to communicate with an external device. The input/output IF 23 functions as an interface for an input device for accepting an input operation from the user, and an output device for presenting information to the user. The memory 25 is for temporarily storing a program, data to be processed by the program, and the like, and is, for example, a volatile memory such as a DRAM (dynamic random access memory). The storage 26 is a storage device for saving data, and is, for example, a flash memory or an HDD (hard disc drive). The processor 29 is hardware for executing a set of instructions written in the program, and includes an arithmetic unit, a register, and a peripheral circuit.

### 1.1 Configuration of Terminal Device 10

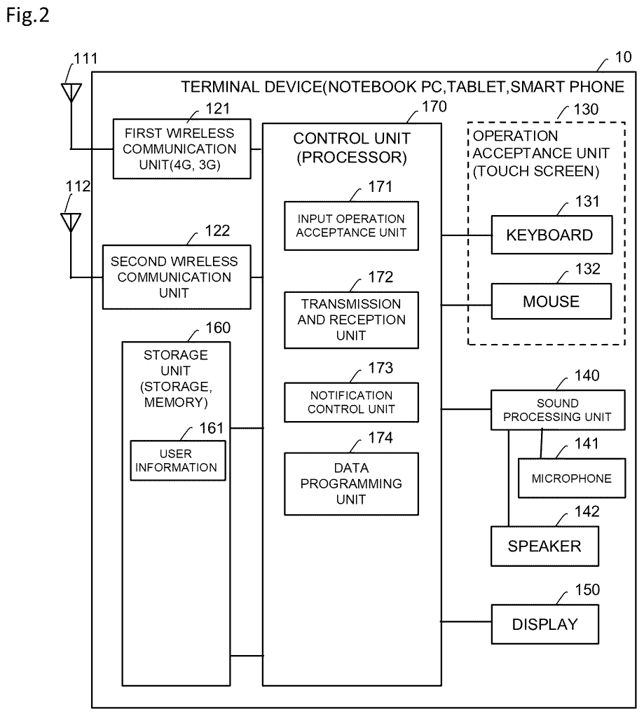

FIG. 2 is a block diagram illustrating a functional configuration of the terminal device 10 constituting the employment registrant management system 1 in Embodiment 1. As illustrated in FIG. 2, the terminal device 10 includes a plurality of antennas (an antenna 111, an antenna 112), wireless communication units (a first wireless communication unit 121, a second wireless communication unit 122) corresponding to the respective antennas, an operation accepting unit 130 (including a keyboard 131 and a mouse 132), a sound processing unit 140, a microphone 141, a speaker 142, a display 150, a storage unit 160, and a control unit 170. The terminal device 10 also has functions and configurations (for example, a battery for holding power, and a power supply circuit that controls the supply of power to each circuit from the battery, and the like) that are not particularly illustrated in FIG. 2. As illustrated in FIG. 2, each block included in the terminal device 10 is electrically connected by buses and the like.

The antenna 111 radiates a signal emitted by the terminal device 10 as an electric wave. In addition, the antenna 111 receives an electric wave from the space, and supplies a received signal to the first wireless communication unit 121.

The antenna 112 radiates a signal emitted by the terminal device 10 as an electric wave. In addition, the antenna 112 receives an electric wave from the space, and supplies a received signal to the second wireless communication unit 122.

The first wireless communication unit 121 performs modulation and demodulation processing for transmitting and receiving signals via the antenna 111, and the like, for the terminal device 10 to communicate with other wireless devices. The second wireless communication unit 122 performs modulation and demodulation processing for transmitting and receiving signals via the antenna 112, and the like, for the terminal device 10 to communicate with other wireless devices. The first wireless communication unit 121 and the second wireless communication unit 122 are communication modules including a tuner, an RSSI (received signal strength indicator) calculation circuit, a CRC (cyclic redundancy check) calculation circuit, a high frequency circuit, and the like. The first wireless communication unit 121 and the second wireless communication unit 122 perform modulation and demodulation and frequency conversion of radio signals that are transmitted and received by the terminal device 10, and supply received signals to the control unit 170.

The operation accepting unit 130 includes a mechanism for accepting an input operation by the user. Specifically, the operation accepting unit 130 includes the keyboard 131 and the mouse 132. Note that the operation accepting unit 130 may be constituted by using, for example, a capacitive touch panel, so as to constitute a touch screen that detects a contact position of the user on the touch panel.

The keyboard 131 accepts an input operation by the user of the terminal device 10. The keyboard 131 is a device for inputting characters, and outputs the information of the input characters to the control unit 170 as input signals.

The mouse 132 accepts an input operation by the user of the terminal device 10. The mouse 132 is a pointing device for, for example, selecting displayed materials that are displayed on the display 150, and outputs the position information selected on the screen and the information indicating that a button is pressed to the control unit 170 as input signals.

The sound processing unit 140 performs modulation and demodulation of a sound signal. The sound processing unit 140 modulates a signal supplied from the microphone 141, and supplies the modulated signal to the control unit 170. In addition, the sound processing unit 140 supplies the sound signal to the speaker 142. The sound processing unit 140 is realized by, for example, a processor for sound processing. The microphone 141 accepts a sound input, and supplies a sound signal corresponding to the sound input to the sound processing unit 140. The speaker 142 converts the sound signal supplied from the sound processing unit 140 to sound, and outputs the sound to the outside of the terminal device 10.

The display 150 displays data such as an image, a moving image, and a text, according to control by the control unit 170. The display 150 is realized by, for example, an LCD (liquid crystal display) or an organic EL (electro-luminescence) display.

The storage unit 160 is constituted by, for example, a flash memory or the like, and stores data and programs used by the terminal device 10. In a certain aspect, the storage unit 160 stores user information 161.

The user information 161 is information of the user who uses the terminal device 10 to perform registration for employment request, presentation of employment recruitment information, application for the employment recruitment information, and the like, which are functions of the employment registrant management system 1. The user information includes information (user ID) for identifying the user, the name of the user, organization information of a company or the like to which the user belongs, and the like.

The control unit 170 controls the operation of the terminal device 10 by reading a program stored in the storage unit 160, and executing instructions included in the program. The control unit 170 is, for example, an application installed in the terminal device 10 in advance. The control unit 170 demonstrates the functions as an input operation accepting unit 171, a transmission and reception unit 172, a notification control unit 173, and a data processing unit 174 by operating according to the program.

The input operation accepting unit 171 performs processing of accepting an input operation by the user to the input device such as the keyboard 131 and the like.

The transmission and reception unit 172 performs processing for the terminal device 10 to transmit and receive data to and from an external device such as the server 20 according to a communication protocol.

The notification control unit 173 performs processing of presenting information to the user. The notification control unit 173 performs processing of causing the display 150 to display a display image, processing of causing the speaker 142 to output sound, and the like.

The data processing unit 174 performs, according to a program, processing of performing calculation on data the input of which is accepted by the terminal device 10, and outputting the calculation result to a memory or the like.

### 1.2 Functional Configuration of Server 20

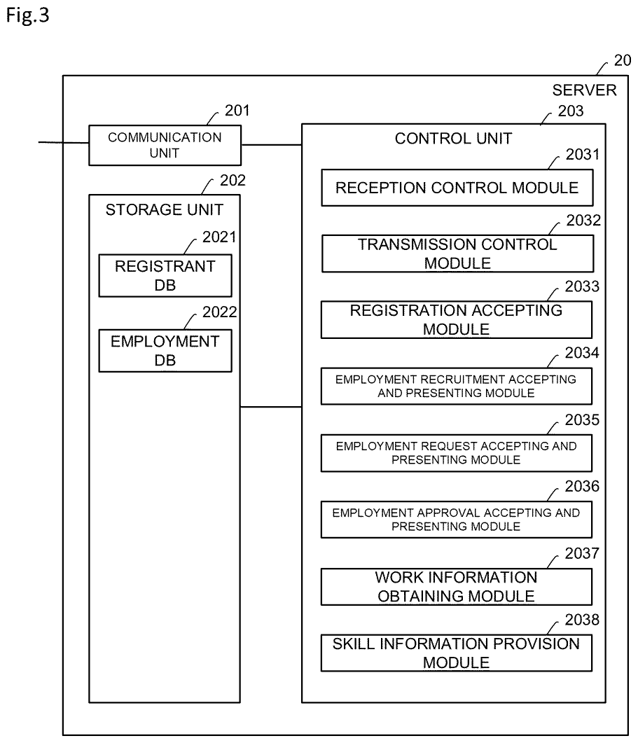

FIG. 3 is a diagram illustrating a functional configuration of the server 20 constituting the employment registrant management system 1 in Embodiment 1. As illustrated in FIG. 3, the server 20 demonstrates the functions as a communication unit 201, a storage unit 202, and a control unit 203.

The communication unit 201 performs processing for the server 20 to communicate with the external device.

The storage unit 202 stores data and programs used by the server 20. The storage unit 202 stores a registrant database 2021, an employment database 2022, and the like.

The registrant database 2021 is a database for holding the information of the registrants registered for employment request in the employment registrant management system 1, and is configured to, for example, provide and register the skill information of the registrants as tag information. Details will be described later.

The employment database 2022 is a database for holding the employment recruitment information registered by the business entities utilizing the employment registrant management system 1, specifically, the information of shifts on the assumption of short-term employment, and the like. Details will be described later.

When the processor 29 of the server 20 performs processing according to a program, the control unit 203 demonstrates, as various modules, the functions illustrated by a reception control module 2031, a transmission control module 2032, a registration accepting module 2033, an employment recruitment accepting and presenting module 2034, an employment request accepting and presenting module 2035, an employment approval accepting and presenting module 2036, a work information accepting module 2037, and a skill information provision module 2038.

The reception control module 2031 controls the processing in which the server 20 receives a signal from the external device according to a communication protocol.

The transmission control module 2032 controls the processing in which the server 20 transmits a signal to the external device according to the communication protocol.

The registration accepting module 2033 controls the processing of accepting registration information from the terminal device 10, since a person who requests employment, who is a user using the employment registrant management system 1, performs, from the terminal device 10, an input of registration information for registration for employment at a business entity. The registration accepting module 2033 accepts the registration information as a registrant who belongs to the business entity that is, for example, a manager or an operator of a store such as a retail store or a restaurant. Here, the registrant who belongs to the business entity may be an employee (internal employee) who is directly hired by the business entity, a former internal employee who was previously hired by the business entity as a full-time employee but already retired, i.e., a so-called OB and OG, a person who was hired by the business entity for a short term (for example, even one day is allowed), or further, a person who is only registered for employment by the business entity and has not been actually employed. The registration information of the registrant may be accepted by, for example, the introduction from another registrant (may be any of an internal employee, an external experienced person, or an external person) who has been already registered as a registrant who belongs to the business entity, and in that case, the information of the registrant who is an introducer may also be accepted.

The registrant accepted by the registration accepting module 2033 may be, in addition to the registrant who belongs to the business entity as described above, for example, a group such as a company operating one or more stores such as retail stores or restaurants, or a person who belongs to a company conducting a franchise chain business, or may be a registrant who does not belong to a specific business entity or group.

Upon acceptance of the registration information, the registration accepting module 2033 stores the registration information in the registrant database 2021. At this time, the registration accepting module 2033 accepts, for example, information such as the name, address, registration location (school, regular workplace, or the like) other than address, contact information, gender, age, and the like of the registrant. Note that, upon acceptance of the registration information, the registration accepting module 2033 may classify and register each registrant as a different attribute depending on whether the registrant is an internal employee, an external experienced person, or an external person.

Furthermore, the registration accepting module 2033 accepts the information of skills based on the past career of the registrant or the information of qualifications related to employment as skill information. Here, the skill information is the information of employment experience of specific business (customer service, cooking experience at restaurants, and the like), and the information of official qualifications and licenses. The skill information may be classified into, for example, the first skill specific to the business entity operating a store such as a retail store or a restaurant, the second skill not limited to such a business entity, and the third skill specific to a group such as a franchise chain including the business entity. Specific examples of the first skill are skills that are useful in business entities, such as having an over-the-counter sales experience at a limited event (a store event at Christmas time), and a time zone manager such as a shift leader. Specific examples of the second skill are skills that are universally useful and not limited to business entities or groups, such as a liquor sales manager and a food hygiene manager, which are official qualifications, and a cooking experience and a customer service experience, which are universal skills. Specific examples of the third skill are skills that are commonly useful in stores developed by the same brand such as a franchise chain, such as having an experience of kitchen operation, an experience of settlement operation, and an experience of stock ordering. The registration accepting module 2033 associates the accepted skill information with the registrant, and stores the skill information in the registrant database 2021 as, for example, tag information. At this time, either or both of a numerical value (for example, the number of times of employment, or the like) and an employment period that are related to the skill information may be registered.

The employment recruitment accepting and presenting module 2034 controls the processing of accepting the employment recruitment information from the business entity. The business entity, which is the user of the employment registrant management system 1, inputs the employment recruitment information from the terminal device 10. The employment recruitment accepting and presenting module 2034 accepts the employment recruitment information transmitted from the terminal device 10. The employment recruitment information that is input by the business entity is information for recruiting workers related to its own business, and may be, for example, employment recruitment information of the working hours during which workers such as student part-timers and part-timers work in retail stores, restaurants, and the like on the assumption of short-term (one-time) employment, i.e., the so-called shifts, may be information of additional recruitment for missing shifts, or may be recruitment information on the assumption of long-term employment such as regular employment. The employment recruitment information may be information for recruitment to be employed by a business entity (for the registrants who are not employed by the business entity concerned), may be information for recruiting shifts for the registrants who are already employed by the business entity, or may be information for recruiting shifts for the registrants who was previously employed by the business entity (may be long-term employment or short-term employment). Specifically, the employment recruitment accepting and presenting module 2034 accepts, as the employment recruitment information, information of the company name or store name of the business entity, the job title or work name related to employment, the number of persons to be recruited, the unit price of wages for a predetermined time period (hourly wage, daily wage, or the like), and the like. At this time, the employment recruitment accepting and presenting module 2034 may accept, together with the employment recruitment information, the skill information related to the employment recruitment information. The skill information related to the employment recruitment information is the skill information essential to employment related to the employment recruitment information, the skill information that is not essential but is desirable for employment, and the like, and is set by the business entity. When the employment recruitment information is accepted, the employment recruitment accepting and presenting module 2034 stores it in the employment database 2022.

In addition, the employment recruitment accepting and presenting module 2034 controls the processing of presenting the accepted employment recruitment information to the registrants accepted by the registration accepting module 2033. Specifically, the employment recruitment accepting and presenting module 2034 presents, as the employment recruitment information, information of the company name or store name of the business entity, the job title or work name related to employment, the number of persons to be recruited, the unit price of wages for a predetermined time period (hourly wage, daily wage, or the like), the skill information related to the employment recruitment information, and the like. At this time, the employment recruitment accepting and presenting module 2034 may present the employment recruitment information only to the registrants with the skill information related to the employment recruitment information.

Note that, when accepting the employment recruitment information from the business entity, the employment recruitment accepting and presenting module 2034 may accept the information indicating the range of attributes of registrants to whom the recruitment information is to be presented for viewing, and corresponding to the range, the employment recruitment accepting and presenting module 2034 may control whether to present the employment recruitment information to internal employees only, to present the employment recruitment information to internal employees, external experienced persons, and external persons, to present the employment recruitment information to the extent of registrants who belong to the business entity, to present the employment recruitment information to the extent of registrants who belong to a group, or to present the employment recruitment information to the extent of registrants who do not belong to a specific business entity or group, and present the employment recruitment information to the relevant registrants.

The employment request accepting and presenting module 2035 controls the processing of accepting, from the registrant, the employment request information for the employment recruitment information. The registrant, who is a user of the employment registrant management system 1, inputs, from the terminal device 10, the employment request information for requesting application to the employment recruitment information presented by the employment recruitment accepting and presenting module 2034. The employment request accepting and presenting module 2035 accepts the employment request information transmitted from the terminal device 10. The employment request accepting and presenting module 2035, accepts, as the employment request information, for example, information such as the user ID for identifying the registrant, the company name or store name of the business entity for which employment is requested, the job title or work name for which employment is requested, and the starting and ending dates and times of work in a case where the employment recruitment information is employment recruitment information (shifts) that assumes short-time employment. At this time, the employment request accepting and presenting module 2035 may accept the skill information of the registrant. At this time, the employment request accepting and presenting module 2035 may accept the employment request information only from the registrant with the skill information related to the employment recruitment information.

In addition, the employment request accepting and presenting module 2035 controls the processing of transmitting and presenting the employment request information accepted by the employment request accepting and presenting module 2035 to the terminal device 10 of the business entity that has input the employment recruitment information. Note that the employment request accepting and presenting module 2035 may classify the employment request information into the internal employee, the external experienced person, and the external person, according to the attributes of the registrant who requests employment, and may present it to the business entity. In addition, the employment request accepting and presenting module 2035 may classify the employment request information into the registrant who belongs to the business entity, the registrant who belongs to the group, and the registrant who does not belong to a specific business entity or group, according to the attributes of the registrant who requests employment, and may present it to the business entity.

The employment request accepting and presenting module 2035 presents a list of registrants who request employment, and presents, for each registrant, the skill information of the registrant. At this time, the employment request accepting and presenting module 2035 may present the skill information of the registrant by classifying the skill information into the first skill specific to the above-described business entity, the second skill not limited to the business entity, and the third skill specific to the group. Specifically, a display frame is provided for each of the first skill, the second skill, and the third skill, one or more items of the skill information of the registrant are displayed as tag information, and the one or more items of the skill information are displayed in a table format, bullet points, or the like. In addition, when presenting the list of registrants who request employment, the employment request accepting and presenting module 2035 may determine the priority based on the skill information of the registrants, and present the list of the registrants based on the priority (for example, in descending order of the priority), or may present the list of the registrants by changing the display mode of the high priority registrants (for example, by highlighting the high priority registrants by changing the color or the like). Furthermore, the employment request accepting and presenting module 2035 may set, for the business entity to which the presentation is performed, the range viewable by the business entity according to the attributes (a store operator, a group administrator, or the like) of the business entity, such as whether to disclose one or more (also including a case where all of them are disclosed) of the first skill, the second skill, and the third skill of the registrants. Specifically, for the business entity operating a store, all of the first skill specific to the business entity, the second skill not limited to the business entity, and the third skill specific to the group regarding the registrants registered under the business entity are made viewable. Only the second skill not limited to the business entity is made viewable for the registrants registered under a business entity that is not the relevant business entity. Only the second skill and the third skill are made viewable for a group such as a franchise chain.

Since the business entity inputs, from the terminal device 10, employment approval information for approving employment of a registrant related to the employment request information presented by the employment request accepting and presenting module 2035, the employment approval accepting and presenting module 2036 controls the processing of accepting the employment approval information from the terminal device 10. The employment approval accepting and presenting module 2036 accepts, as the employment approval information, information such as the user ID for identifying the registrant, the company name or store name of the business entity that approves employment, the job title or work name, and the starting and ending dates and times of work.

In addition, the employment approval accepting and presenting module 2036 controls the processing of transmitting the accepted employment request information to the terminal device 10 of the registrant who has input the employment request information, and presenting it to the approved registrant.

The work information accepting module 2037 controls the processing of accepting, from the terminal device 10, the work information indicating that the registrant to whom the employment approval accepting and presenting module 2036 transmitted the employment approval information has been actually employed. The work information accepting module 2037 accepts, as the work information, for example, information such as the user ID for identifying the registrant, the company name or store name of the business entity by which the registrant has been employed, the job title or work name, the starting and ending dates and times of work, and the skill information related to the employment. The work information accepting module 2037 may accept the work information as described above from the business entity as a function of the server 20, or may obtain it from an external web server through API integration or the like. The external web server here is, for example, a web server that provides a service for managing attendance information as a SaaS.

The skill information related to the employment accepted by the work information accepting module 2037 is the name of work performed by the registrant, the work hours, and the like in the employment. Specific examples of the skill information related to the employment is the specific names of work such as “over-the-counter sales at a limited event or the like”, “kitchen operation”, “settlement operation”, and “stock ordering”.

The skill information provision module 2038 controls the processing of obtaining the skill information regarding skills based on the work information accepted by the work information accepting module 2037, and providing the obtained skill information in association with the information of the registrant. The skill information provision module 2038 extracts, for example, the skill information related to the employment included in the work information, and provides the skill information in association with the information of the registrant stored in the registrant database 2021 to store it as tag information. Here, the skill information is, for example, as described above, the information of employment experience of specific business (customer service, cooking experience at restaurants, and the like), and the information of certifications, official qualifications, and licenses inside and outside the business entity. Note that the skill information provision module 2038 may obtain the skill information registered in advance when the employment recruitment information was registered as the skill information based on the work information. In addition, the skill information provision module 2038 classifies the skill information of the registrant into the first skill specific to the above-described business entity, the second skill not limited to the business entity, and the third skill specific to the group, and provides it to the skill information of the registrant. In addition, the skill information provision module 2038 updates either or both of a numerical value (for example, the number of times of employment, or the like) and an employment period that are related to the skill information of the registrant based on the work information.

Specifically, the skill information provision module 2038 obtains the skill information as follows. For example, suppose that there is information of “over-the-counter sales at a limited event or the like”, “kitchen operation”, “settlement operation”, and “stock ordering” as described above in the work information accepted by the work information accepting module 2037. Then, the skill information provision module 2038 refers to the registration information of the registrant who is a target of the work information, and when these items of information are not provided as the tag information as the skill information, the skill information provision module 2038 newly provides these items of information as the tag information. In addition, when these items of information have been already provided as the tag information as the skill information, the skill information provision module 2038 updates the numerical value and the employment period that are related to the skill information by adding the current work information.

For example, when providing the skill information, the skill information provision module 2038 may provide the skill information when the registrant or the business entity applies for the skill information, and the business entity or other person (an administrator, or the like) approves it. An example of the skill information at this time is a case such as certification inside and outside the business entity.

### 2 Data Structure

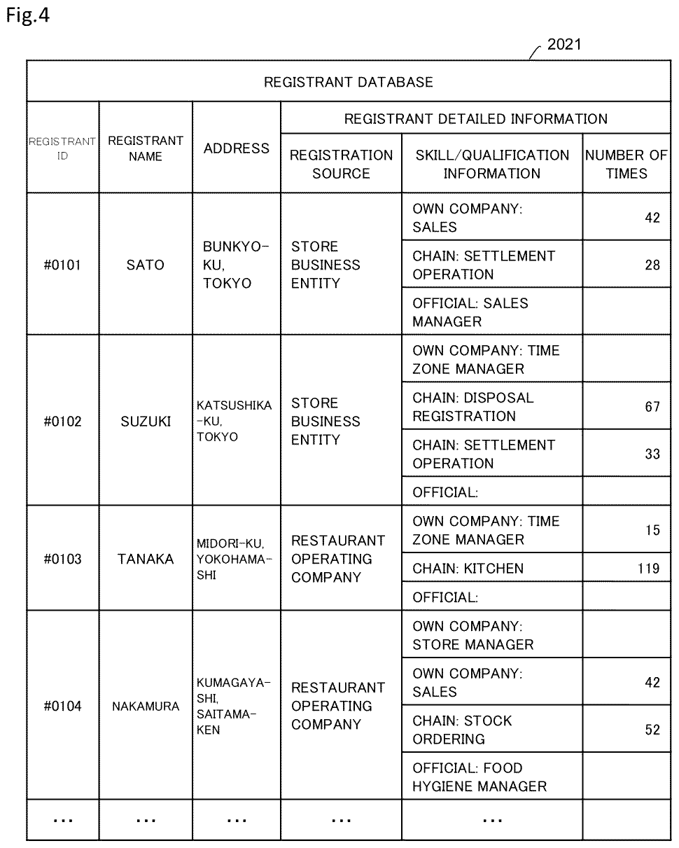

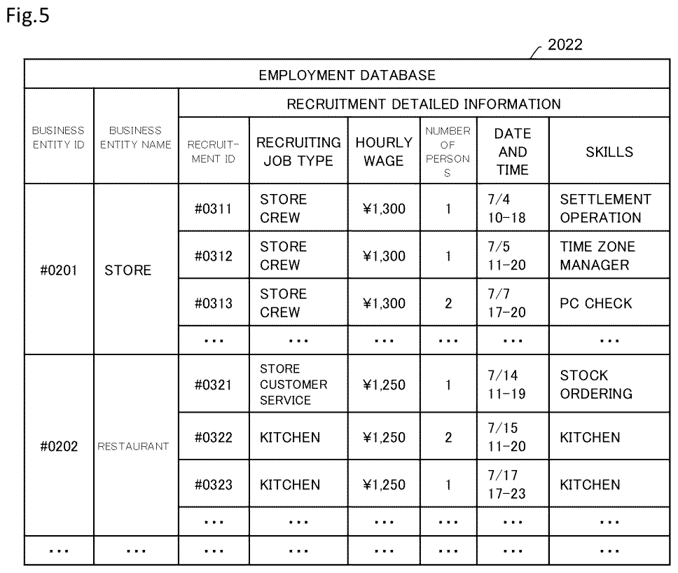

FIG. 4 is a diagram illustrating an example of a data structure of the registrant database 2021 stored in the server 20. In addition, FIG. 5 is a diagram illustrating an example of a data structure of the employment database 2022 stored in the server 20.

As illustrated in FIG. 4, each record of the registrant database 2021 includes an item “registrant ID”, an item “registrant name”, an item “address”, an item “registrant detailed information”, etc.

The item “registrant ID” is the information for identifying each registrant accepted by the employment registrant management system 1 for an employment request.

The item “registrant name” is the name of the registrant accepted by the employment registrant management system 1 for the employment request.

The item “address” is the address of the registrant accepted by the employment registrant management system 1 for the employment request. Note that, in this item, a registration location (school, regular workplace, or the like) other than the address may be stored.

The item “registrant detailed information” is the information regarding the registrant accepted by the employment registrant management system 1 for the employment request, and specifically includes an item “registration source”, an item “skill/qualification information”, an item “number of times”, etc.

The item “registration source” is the information indicating the attribute of the registrant who has registered in the employment registrant management system 1 for the employment request. Specifically, when the registrant is a registrant who belongs to a specific business entity, or a registrant who belongs to a group, the information of the business entity or the group is stored.

The item “skill/qualification information” stores information about the skills or qualification of the registrant who has registered in the employment registrant management system 1 for the employment request. The information stored in the item “skill/qualification information” is the information of the employment experience in a specific business, and the information of official qualifications and licenses as illustrated in FIG. 4, and the specific names of work such as “settlement operation”, “kitchen”, and “stock ordering”, and the names of official qualifications and the like are stored as specific examples. In addition, “own company” illustrated in FIG. 4 indicates the first skill specific to the business entity, “official” indicates the second skill not limited to the business entity, and “chain” indicates the third skill specific to the group. One or more items of the information about these skills or qualification are stored in association with each item “registrant ID”.

The item “number of times” is the number of times the registrant who has registered in the employment registrant management system 1 for the employment request has been employed related to the skill information, which is an example of the information related to the skill information stored in the item “skill/qualification information”.

Note that, although the registrant database 2021 may include the employment period related to the skill information, illustration is omitted.

When registration information is accepted from a user, the registration accepting module 2033 of the server 20 adds a record to the registrant database 2021.

As illustrated in FIG. 5, each record of the employment database 2022 includes an item “business entity ID”, an item “business entity name”, an item “recruitment detailed information”, etc.

The item “business entity ID” is the information for identifying each business entity that registers the employment recruitment information with the employment registrant management system 1.

The item “business entity name” is the information indicating the name of the business entity that registers the employment recruitment information with the employment registrant management system 1, and for example, the name of a store, the name of a franchise chain, or the name of a corporation is stored.

The item “recruitment detailed information” is the information regarding the employment recruitment information registered in the employment registrant management system 1 by the business entity, and specifically includes an item “recruitment ID”, an item “recruiting job type”, an item “hourly wage”, an item “number of persons”, an item “date and time”, an item “skills”, etc. This item “recruitment detailed information” is configured so that a record is registered each time the business entity represented by the item “business entity name” registers employment recruitment information.

The item “recruitment ID” is the information for identifying each employment recruitment information registered in the employment registrant management system 1 by the business entity.

The item “recruiting job type” is the information indicating the job type related to the employment recruitment information registered in the employment registrant management system 1 by the business entity. Specifically, it is the work content in the case of actually being employed for the recruitment, and in the example illustrated in FIG. 4, “store crew” that performs various kinds of work in a store of a convenience store, and “store customer service” that performs customer service in a store of a restaurant are stored.

The item “hourly wage” is the information indicating the unit price of the salary in the predetermined time period in the case of actual employment for the recruitment registered in the employment registrant management system 1 by the business entity, and the hourly wage is illustrated as an example.

The item “number of persons” is the information indicating the number of persons for the employment recruitment information registered in the employment registrant management system 1 by the business entity.

The item “date and time” stores the information indicating the scheduled employment date and time of a shift in the employment recruitment information registered in the employment registrant management system 1 by the business entity.

The item “skills” is the skill information related to the employment recruitment information registered in the employment registrant management system 1 by the business entity, and as an example of the skill information related to the employment recruitment information, the skill information essential for employment related to the employment recruitment information is stored. The item “skills” stores the information of the employment experience in a specific business, and the information of official qualifications and licenses, corresponding to the item “skill/qualification information” of the registrant database 2021. The information stored in the item “skills” is the skill information corresponding to the item “skill/qualification information” of the registrant database 2021, specific examples are the specific names of work such as “settlement operation”, “disposal registration”, and “kitchen”, and the names of official qualifications and the like, and as described above, one or more of the first skill specific to the business entity, the second skill not limited to the business entity, and the third skill specific to the group are stored.

When the employment recruitment information is accepted from the user, the employment recruitment accepting and presenting module 2034 of the server 20 adds a record to the item “recruitment detailed information” of the employment database 2022.

### 3 Operation

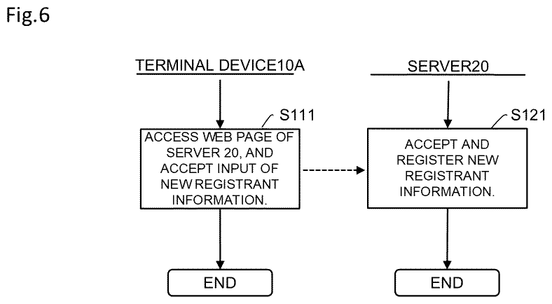

Hereinafter, referring to FIG. 6 to FIG. 8, a description will be given of registration processing, employment approval processing, and skill information provision processing by the employment registrant management system 1 in a first embodiment. Note that, in FIG. 6 to FIG. 8, it is assumed that a terminal device used by a registrant is the terminal device 10A, and a terminal device used by a business entity is the terminal device 10B.

FIG. 6 is a flowchart illustrating an example of a flow for performing the registration processing by the employment registrant management system 1 in Embodiment 1.

As a precondition for performing the processing in step S111, the input operation accepting unit 171 of the terminal device 10A accepts, from the user who registers as a registrant for employment for the business entity, an operation of inputting a user ID and a password for performing authentication required for utilizing services of the employment registrant management system 1. The transmission and reception unit 172 transmits the accepted user ID and password, and the user information to the server 20. The transmission and reception unit 172 of the terminal device 10A accepts the authentication completion information, and the display data of a registration information inputting screen for accepting registration information that are transmitted from the server 20. The notification control unit 173 displays the accepted authentication completion information and registration information inputting screen on the display 150, and the processing in step S111 is started.

In step S111, the input operation accepting unit 171 of the terminal device 10A accepts an input of the registration information registered by the user, specifically, personal information, skill information, and the like of the registrant, through an operation by the user via the registration information inputting screen. The transmission and reception unit 172 transmits the accepted registration information to the server 20.

In step S121, the registration accepting module 2033 of the server 20 accepts the registration information transmitted from the terminal device 10A via the communication unit 201. In addition, the registration accepting module 2033 accepts, as the skill information, the information of skills based on the past career of the registrant, or the information of qualifications related to employment, specifically, the information of employment experience of specific business (customer service, cooking experience at restaurants, and the like), and the information of official qualifications and licenses. In addition, when the registration information is accepted, the registration accepting module 2033 stores the registration information in the registrant database 2021, and stores the accepted skill information in the registrant database 2021 as the tag information to be associated with the registrant.

As described above, in the employment registrant management system 1, when the registration information is accepted from the user who registers as a registrant for employment for the business entity, each registrant is registered. In addition, the information of skills based on the past career of the registrant, or the information of qualifications related to employment is accepted as the skill information.

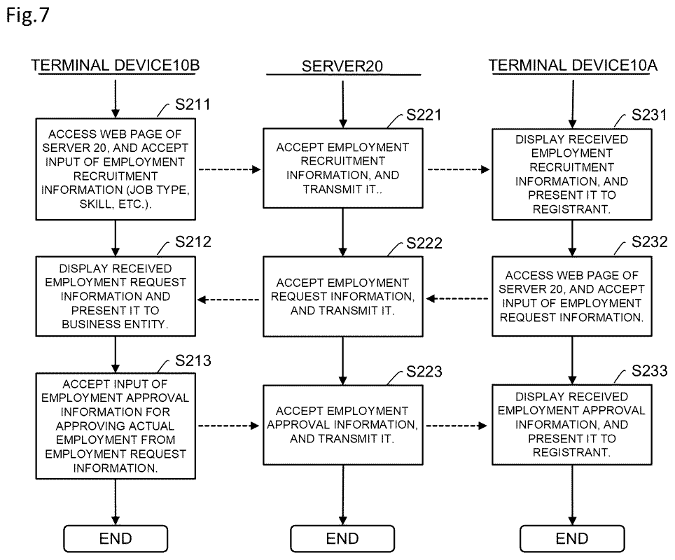

FIG. 7 is a flowchart illustrating an example of a flow for performing the employment approval processing by the employment registrant management system 1 in Embodiment 1.

In step S211, the input operation accepting unit 171 of the terminal device 10B accepts, through an operation by the user, an input of the employment recruitment information registered by the user, specifically, as the employment recruitment information, the company name or store name of the business entity, the job title or work name related to employment, the number of persons to be recruited, the information of the unit price of the salary in a predetermined time period, the skill information related to the employment recruitment information (for example, the essential skill information, the skill information that is not essential but is desirable for employment), and the like. The transmission and reception unit 172 transmits the accepted employment recruitment information to the server 20.

In step S221, the employment recruitment accepting and presenting module 2034 of the server 20 accepts the employment recruitment information transmitted from the terminal device 10B via the communication unit 201. The employment recruitment accepting and presenting module 2034 stores the accepted employment recruitment information in the employment database 2022. The employment recruitment accepting and presenting module 2034 transmits the accepted employment recruitment information to the terminal device 10A of the registrant stored in the registrant database 2021 via the communication unit 201.

In step S231, the transmission and reception unit 172 of the terminal device 10A accepts the employment recruitment information (or the information indicating that the employment recruitment information has been updated, and new employment recruitment information has been registered) transmitted from the server 20. The notification control unit 173 displays the accepted employment recruitment information on the display 150.

In step S232, the input operation accepting unit 171 of the terminal device 10A accepts an input of employment request information, which is application for the employment recruitment information displayed on the display 150, through an operation by the user. The transmission and reception unit 172 transmits the accepted employment request information and response deadline to the server 20.

In step S222, the employment request accepting and presenting module 2035 of the server 20 accepts the employment request information transmitted from the terminal device 10A via the communication unit 201. The employment request accepting and presenting module 2035 transmits the accepted employment request information to the terminal device 10A of the business entity that has input the employment recruitment information via the communication unit 201.

In step S212, the transmission and reception unit 172 of the terminal device 10B accepts the employment request information transmitted from the server 20. The notification control unit 173 displays the accepted employment request information on the display 150.

In step S213, the input operation accepting unit 171 of the terminal device 10B accepts, through an operation by the user, an input of the employment approval information that approves employment of the registrant for the employment request information displayed on the display 150. The transmission and reception unit 172 transmits the accepted employment approval information to the server 20.

In step S223, the employment approval accepting and presenting module 2036 of the server 20 accepts the employment approval information transmitted from the terminal device 10B via the communication unit 201. The employment approval accepting and presenting module 2036 transmits the accepted employment approval information to the terminal device 10A of the registrant who has input the employment request information via the communication unit 201.

In step S233, the transmission and reception unit 172 of the terminal device 10A accepts the employment approval information transmitted from the server 20. The notification control unit 173 displays the accepted employment approval information on the display 150.

As described above, in the employment registrant management system 1, when the employment recruitment information is accepted from the user that is the business entity, the employment recruitment information is presented to the registrant. When the employment request information for the employment recruitment information is accepted from the registrant, it is presented to the business entity that has registered the employment recruitment information. When the employment approval information for the employment request information is accepted from the business entity, it is presented to the registrant who has registered the employment request information. Accordingly, it becomes possible for the registrant to be smoothly employed by the business entity.

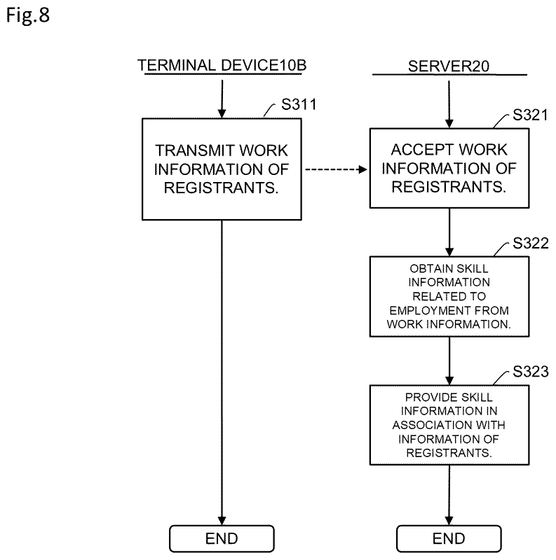

FIG. 8 is a flowchart illustrating an example of a flow for performing the skill information provision processing by the employment registrant management system 1 in Embodiment 1.

In step S311, the input operation accepting unit 171 of the terminal device 10B accepts, through an operation by the user that is the business entity, an input operation for transmitting the work information indicating that the registrant has been actually employed. The transmission and reception unit 172 transmits the work information to the server 20, according to the input operation by the user.

In step S321, the work information accepting module 2037 of the server 20 accepts the work information of the registrant transmitted from the terminal device 10B via the communication unit 201.

In step S322, the skill information provision module 2038 of the server 20 obtains the skill information regarding skills based on the work information accepted in step S321. The skill information provision module 2038 extracts, for example, information such as “over-the-counter sales at a limited event or the like”, “kitchen operation”, “settlement operation”, and “stock ordering”, which are the specific contents of work, from the work information.

In step S323, the skill information provision module 2038 of the server 20 provides the skill information extracted in step S322 in association with the information of the registrants as the tag information. The skill information provision module 2038 provides, for example, the information such as “over-the-counter sales at a limited event or the like”, “kitchen operation”, “settlement operation”, and “stock ordering” extracted in step S322 as the tag information. At this time, the skill information provision module 2038 refers to the registration information of the registrant, who is a target of the work information, and when these items of information are not provided as the tag information as the skill information, the skill information provision module 2038 newly provides these items of information as the tag information. In addition, when these items of information have been already provided as the tag information as the skill information, the skill information provision module 2038 updates the numerical value and the employment period that are related to the skill information by adding the current work information.

For example, as in an example stored in the employment database 2022 illustrated in FIG. 5, in a case where a registrant applies for and is employed for the employment recruitment information having “#0311” stored in the item “recruitment ID”, suppose that the registrant has actually performed “settlement operation” stored in the item “skills” during employment. In this case, in step S322, the information of “settlement operation” is extracted as the work information.

In this example, as in an example stored in the registrant database 2021 illustrated in FIG. 4, when the employed registrant is a registrant having “#0102” as the item “registrant ID”, since the “settlement operation” is not stored in the item “skill/qualification information”, in step S323, the “settlement operation”, which is new tag information, is provided to the item “skill/qualification information.” In addition, in the case of a registrant having “#0101” as the item “registrant ID”, since the “settlement operation” is stored in the item “skill/qualification information”, in step S323, the value “28” of the item “number of times” associated with the “settlement operation” of the item “skill/qualification information” is updated by adding one.

As described above, in the employment registrant management system 1, the skill information regarding skills is obtained from work information indicating that the registrants have applied and worked for the employment recruitment information of the business entity. Then, the obtained skill information is provided in association with the information of the registrants. This makes it possible to manage the skills of the registrants in detail and in real time.

### 4 Screen Example

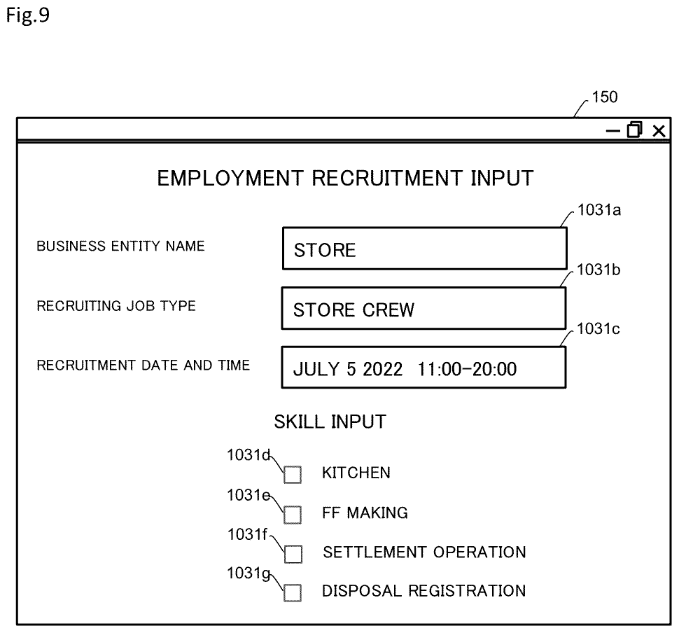

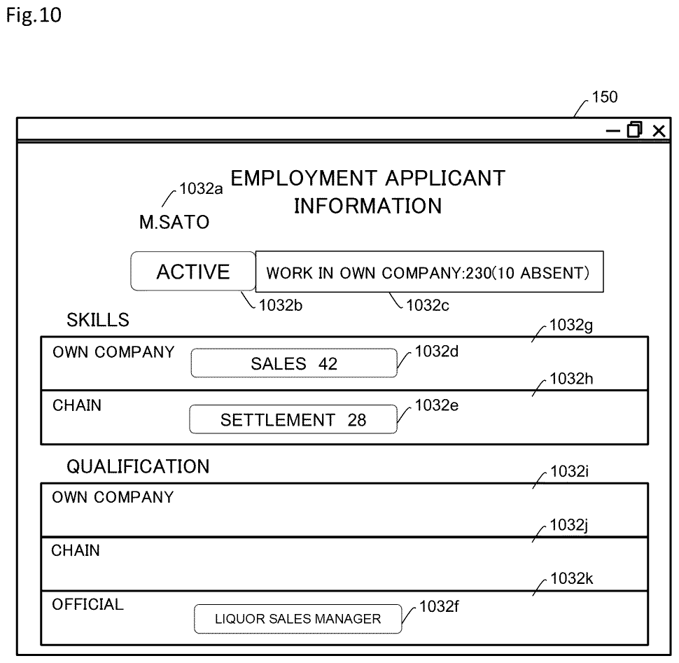

Hereinafter, referring to FIG. 9 and FIG. 10, a description will be given of an example of a screen that accepts employment recruitment from a business entity, and an example of a screen that displays employment applicants by the employment registrant management system 1.

FIG. 9 is a diagram illustrating the example of the screen that accepts employment recruitment and that is displayed on the terminal device 10. The example of the screen in FIG. 9 illustrates an example of the screen in a state where a user, which is a business entity, is inputting information to an employment recruitment inputting screen for inputting employment recruitment information (recruitment information). It corresponds to step S211 in FIG. 7.

As illustrated in FIG. 9, the employment recruitment inputting screen for the business entity to input the employment recruitment information is displayed on the display 150 of the terminal device 10. This employment recruitment inputting screen displays a business entity name input column 1031a, a recruiting job type input column 1031b, and a recruitment date and time input column 1031c. In addition, the employment recruitment inputting screen is provided with skill selection buttons 1031d, 1031e, 1031f, and 1031g for accepting the skill information related to the employment recruitment information.

In the screen illustrated in FIG. 9, the skill selection buttons 1031d, 1031e, 1031f, and 1031g are radio buttons for selecting the skill information requested for the skills of registrants. The skill information that can be selected by these skill selection buttons 1031d, 1031e, 1031f, and 1031g correspond to the information stored in the item “skill/qualification information” of the registrant database 2021, and the information stored in the item “skills” of the employment database 2022. When the business entity, which is the user, requests for the skill information of “kitchen”, “FF cooking”, “settlement operation”, and “disposal registration” as in the example illustrated in FIG. 9 in the employment recruitment, the business entity checks the skill selection buttons 1031d, 1031e, 1031f, and 1031g, respectively, by clicking them or the like. Accordingly, it is configured to be reflected to the skill information of the employment recruitment information.

The specific names of work such as “settlement operation”, “disposal registration”, and “kitchen”, and the names of official qualifications and the like are displayed as specific examples for the skill information that can be selected by the skill selection buttons 1031d, 1031e, 1031f, and 1031g. These items of display information are the first skill specific to the business entity, the second skill not limited to the business entity, and the third skill specific to the group as described above, and each is configured to allow selection of one or more items of the skill information. Note that, although illustration is omitted, a display column may be configured to be separated for each of the first skill, the second skill, and the third skill to allow selection of the skill information corresponding to each of them. In addition, for example, the business entity operating a store may be able to newly create skill information of the first skill specific to the business entity, but unable to newly create the second skill and the third skill, and only be able to select them. Furthermore, the group such as a franchise chain may be able to newly create the skill information of the third skill specific to the group, but unable to newly create the first skill and the second skill, and only be able to select them.

FIG. 10 is a diagram illustrating an example of a screen that displays employment applicants and that is displayed on the terminal device 10. The example of the screen in FIG. 10 illustrates an example of a screen in a state where the user, which is the business entity, has displayed the detailed information of a registrant who has applied for the employment recruitment information. It corresponds to step S213 in FIG. 7.

As illustrated in FIG. 10, the employment applicant display screen showing the detailed information of the employment applicant who has applied for the employment recruitment information is displayed on the display 150 of the terminal device 10. A registrant name display column 1032a, an attribute display column 1032b for showing the attributes of the registrant, and a work achievements display column 1032c showing the work achievements of the registrant are displayed on this employment applicant display screen. In addition, items of tag information 1032d, 1032e, and 1032f that indicate skills are displayed on the employment applicant display screen as examples of the skill information provided to the registrant.

The skill information indicated by the items of tag information 1032d, 1032e, and 1032f is classified into the first skill specific to the business entity, the second skill not limited to the business entity, and the third skill specific to the group as described above, and is respectively classified and stored in the registrant database 2021 as illustrated in FIG. 4. Corresponding to this, as in the example of the screen illustrated in FIG. 10, there are provided an own company skill display column 1032g for displaying skills of its own company (the first skill), a chain skill display column 1032h for displaying skills in a chain (the third skill), an own company qualification display column 1032i for displaying qualifications of its own company (the first skill), a chain qualification display column 1032j for displaying qualifications in the chain (the third skill), and an official qualification display column 1032k for displaying official qualifications (the second skill). Accordingly, it is possible to identify the skill information of the registrant at a glance.

### SUMMARY

As described above, according to the present embodiment, when registration information is accepted from a user who registers as a registrant for employment by a business entity, the information of skills based on the past career of the registrant or the information of qualifications related to employment is accepted as skill information, and is registered as the skill information of the registrant. In addition, when employment recruitment information is accepted from a user, which is the business entity, the employment recruitment information is presented to the registrant, when employment request information for the employment recruitment information is accepted from the registrant, the employment request information is presented to the business entity that has registered the employment recruitment information, and when employment approval information for the employment request information is accepted from the business entity, the employment approval information is presented to the registrant who has registered the employment request information. Thereafter, the skill information regarding skills is obtained from the work information indicating that the business entity has worked, and the obtained skill information is provided in association with the information of the registrant. Therefore, the work information of the registrant can be reflected as tag information that indicates the real time skills. This makes it possible to manage the skills of registrants in detail and in real time.

In addition, according to the present embodiment, when accepting the employment recruitment information from the business entity, the skill information related to the employment recruitment information is accepted, and is presented to the registrant. In addition, when accepting the employment request information from the registrant, the skill information of the registrant is presented to the business entity. Therefore, the registrant can identify the skill information required for the employment, and the business entity can identify the skill information of the registrant. Accordingly, it is possible to provide employment matching based on appropriate skill information.

Furthermore, according to the present embodiment, the skill information is provided and managed as the first skill specific to the business entity, the second skill not limited to the business entity, or the third skill specific to the group including the business entity. Accordingly, since the skills can be hierarchically managed, it becomes possible to appropriately manage the skills of the registrants.

Although the embodiments according to the disclosure have been described above, these can be implemented in other various modes, and can be implemented by making various kinds of omission, substitution, and changes. These embodiments and modifications, and those to which omissions, substitutions, and changes have been made are included in the technical scope of the claims and its equivalent scope.

### <Supplement>

The matters described in each embodiment described above are supplemented as follows.

(Supplement 1) An information processing apparatus that includes the control unit 203 and the storage unit 202, and that is for managing registrants who are registered for employment by a business entity, wherein the storage unit 202 stores information of the registrants (2021), and the control unit 203 performs the steps of accepting employment recruitment information from the business entity, and presenting the employment recruitment information to the registrants (S221), obtaining work information indicating that the registrants have been employed related to the employment recruitment information with approval from the business entity (S321), and obtaining skill information regarding skills based on the work information, and providing the obtained skill information in association with stored information of the registrants (S323).

(Supplement 2) An information processing apparatus according to (supplement 1), wherein the program further performs the steps of accepting, from the registrants who request application for the employment recruitment information, employment request information for the employment recruitment information, and presenting the employment request information to the business entity (S222), and accepting, from the business entity, employment approval information for approving employment of the registrants related to the accepted employment request information, and presenting the employment approval information to the registrants (S223).

(Supplement 3) An information processing apparatus according to (supplement 1) or (supplement 2), wherein, in the step of accepting the employment recruitment information, the skill information related to the employment recruitment information is accepted with the employment recruitment information.

(Supplement 4) An information processing apparatus according to (supplement 3), wherein, in the step of providing the obtained skill information, the skill information related to the accepted employment recruitment information is provided as the skill information based on the work information.

(Supplement 5) An information processing apparatus according to (supplement 3), wherein, in the step of accepting the employment recruitment information and presenting the employment recruitment information to the registrants, the employment recruitment information is presented only to the registrants with the skill information related to the accepted employment recruitment information.

(Supplement 6) An information processing apparatus according to (supplement 2), wherein, in the step of accepting the employment request information for the employment recruitment information, the employment request information is accepted only from the registrants with the skill information related to the accepted employment recruitment information.

(Supplement 7) An information processing apparatus according to (supplements 6), wherein, in the step of providing the obtained skill information, the obtained skill information based on the work information is provided as a first skill specific to the business entity or a second skill not limited to the business entity.

(Supplement 8) An information processing apparatus according to (supplement 7), wherein the obtained skill information based on the work information is provided as the first skill, as the second skill, or a third skill specific to a group including the business entity.

(Supplement 9) An information processing apparatus according to (supplement 8), wherein, in the step of presenting the employment request information for the employment recruitment information to the business entity, the skill information provided to the registrants is presented for each of the first skill, the second skill, or the third skill.

(Supplement 10) An information processing apparatus according to (supplement 9), wherein a range viewable by the business entity that views the skill information is set for each of the first skill, the second skill, or the third skill.

(Supplement 11) An information processing apparatus according to (supplement 10), wherein, in the step of presenting the employment request information to the business entity, for the registrants related to the employment request information, a priority based on the skill information related to the employment recruitment information is determined from the skill information provided to the registrants, and a list of the registrants related to the employment request information is presented based on the priority.

(Supplement 12) An information processing apparatus according to (supplement 11), wherein a mode for presenting the registrants related to the employment request information is changed based on the priority.

(Supplement 13) An information processing apparatus according to (supplement 1), wherein, in the step of providing the obtained skill information, either or both of a numerical value related to the skill information provided to the registrants and an employment period related to the skill information provided to the registrant are updated according to the work information.

(Supplement 14) A method that is to be executed by the computer including the processor 29 and the memory 25, and that is for managing registrants who are registered for employment by a business entity, wherein the memory 25 stores information of the registrants (2021), and in the method, the processor 29 performs the steps of accepting employment recruitment information from the business entity, and presenting the employment recruitment information to the registrants (S221), obtaining work information indicating that the registrants have been employed related to the employment recruitment information with approval from the business entity (S321), and obtaining skill information regarding skills based on the work information, and providing the obtained skill information in association with stored information of the registrants (S323).

(Supplement 15) A non-transitory computer readable medium that stores a program that is to be executed by the computer including the processor 29 and the memory 25, and that is for managing registrants who are registered for employment by a business entity, wherein the memory 25 stores (2021) information of the registrants, the program causes the processor 29 to perform the steps of accepting employment recruitment information from the business entity, and presenting the employment recruitment information to the registrants (S221), obtaining work information indicating that the registrants have been employed related to the employment recruitment information with approval from the business entity (S321), and obtaining skill information regarding skills based on the work information, and providing the obtained skill information in association with stored information of the registrants (S323).

### REFERENCE SIGNS LIST

1: Employment registrant management system
10: Terminal device
10A: Terminal device
10B: Terminal device
13: Input device
14: Output device
15: Memory
16: Storage unit
19: Processor
20: Server
25: Memory
26: Storage
29: Processor
80: Network
81: Wireless base station
82: Wireless LAN router
111: Antenna
112: Antenna
121: First wireless communication unit
122: Second wireless communication unit
130: Operation accepting unit
131: Keyboard
132: Mouse
140: Sound processing unit
141: Microphone
142: Speaker
150: Display
160: Storage unit
161: User information
170: Control unit
171: Input operation accepting unit
172: Transmission and reception unit
173: Notification control unit
174: Data processing unit
201: Communication unit
202: Storage unit
203: Control unit
2021: Registrant database
2022: Employment database
2031: Reception control module
2032: Transmission control module
2033: Registration accepting module
2034: Employment recruitment accepting and presenting module
2035: Employment request accepting and presenting module
2036: Employment approval accepting and presenting module
2037: Work information accepting module
2038: Skill information provision module

1. An information processing apparatus that includes a control unit and a storage unit, and that is for managing registrants who are registered for employment by a business entity, wherein
the storage unit stores information of the registrants, and
the control unit performs steps of:
accepting employment recruitment information from the business entity, and presenting the employment recruitment information to the registrants;
obtaining work information indicating that the registrants have been employed related to the employment recruitment information with approval from the business entity; and
obtaining skill information regarding skills based on the work information, and providing the obtained skill information in association with stored information of the registrants.

2. The information processing apparatus according to claim 1, wherein the program further performs steps of:
accepting, from the registrants who request application for the employment recruitment information, employment request information for the employment recruitment information, and presenting the employment request information to the business entity; and
accepting, from the business entity, employment approval information for approving employment of the registrants related to the accepted employment request information, and presenting the employment approval information to the registrants.

3. The information processing apparatus according to claim 1, wherein, in the step of accepting the employment recruitment information, the skill information related to the employment recruitment information is accepted with the employment recruitment information.

4. The information processing apparatus according to claim 3, wherein, in the step of providing the obtained skill information, the skill information related to the accepted employment recruitment information is provided as the skill information based on the work information.

5. The information processing apparatus according to claim 3, wherein, in the step of accepting the employment recruitment information and presenting the employment recruitment information to the registrants, the employment recruitment information is presented only to the registrants with the skill information related to the accepted employment recruitment information.

6. The information processing apparatus according to claim 2, wherein, in the step of accepting the employment request information for the employment recruitment information, the employment request information is accepted only from the registrants with the skill information related to the accepted employment recruitment information.

7. The information processing apparatus according to claim 6, wherein, in the step of providing the obtained skill information, the obtained skill information based on the work information is provided as a first skill specific to the business entity or a second skill not limited to the business entity.

8. The information processing apparatus according to claim 7, wherein the obtained skill information based on the work information is provided as the first skill, as the second skill, or a third skill specific to a group including the business entity.

9. The information processing apparatus according to claim 8, wherein, in the step of presenting the employment request information for the employment recruitment information to the business entity, the skill information provided to the registrants is presented for each of the first skill, the second skill, or the third skill.

10. The information processing apparatus according to claim 9, wherein a range viewable by the business entity that views the skill information is set for each of the first skill, the second skill, or the third skill.

11. The information processing apparatus according to claim 10, wherein, in the step of presenting the employment request information to the business entity, for the registrants related to the employment request information, a priority based on the skill information related to the employment recruitment information is determined from the skill information provided to the registrants, and a list of the registrants related to the employment request information is presented based on the priority.

12. The information processing apparatus according to claim 11, wherein a mode for presenting the registrants related to the employment request information is changed based on the priority.

13. The information processing apparatus according to claim 1, wherein, in the step of providing the obtained skill information, either or both of a numerical value related to the skill information provided to the registrants and an employment period related to the skill information provided to the registrant are updated according to the work information.

14. A method that is to be executed by a computer comprising a processor and a memory, and that is for managing registrants who are registered for employment by a business entity, wherein
the memory stores information of the registrants, and
in the method, the processor performs steps of:
accepting employment recruitment information from the business entity, and presenting the employment recruitment information to the registrants;
obtaining work information indicating that the registrants have been employed related to the employment recruitment information with approval from the business entity; and
obtaining skill information regarding skills based on the work information, and providing the obtained skill information in association with stored information of the registrants.

15. A non-transitory computer readable medium that stores a program that is to be executed by processing circuitry, and that is for managing registrants who are registered for employment by a business entity, wherein
the medium stores information of the registrants,
the program causes the processor to perform steps of:
accepting employment recruitment information from the business entity, and presenting the employment recruitment information to the registrants;
obtaining work information indicating that the registrants have been employed related to the employment recruitment information with approval from the business entity, and
obtaining skill information regarding skills based on the work information, and providing the obtained skill information in association with stored information of the registrants.
